(19) United States
(12) Patent Application Publication
(10) Pub. No.: US 2020/0161788 A1
(43) Pub. Date: May 21, 2020

(54) ELECTRICAL CONNECTOR ASSEMBLY

(71) Applicants: Inventec (Pudong) Technology Corporation, Shanghai (CN); INVENTEC CORPORATION, Taipei City (TW)

(72) Inventor: Wen-Ching LIN, TAIPEI CITY (TW)

(21) Appl. No.: 16/221,627

(22) Filed: Dec. 17, 2018

(30) Foreign Application Priority Data
Nov. 21, 2018 (CN) 201811391898.4

(51) Int. Cl. H01R 13/24; H01R 13/08; H01R 13/631; H01R 13/506

(52) U.S. Cl. CPC H01R 13/2421; H01R 13/08; H01R 13/506; H01R 13/2471; H01R 13/631

(57) ABSTRACT

An electrical connector assembly includes a first connector and a second connector. The first connector includes plural pogo pins and two positioning pins located between the pogo pins. The second connector includes plural contact pads and two positioning holes. The contact pads are configured to be electrically coupled with the pogo pins. The positioning holes are located between the contact pads. Each positioning hole is configured to surround and contact a corresponding one of the two positioning pins, so as to restrict relative motion between the first connector and the second connector along their connection interface.

### RELATED APPLICATIONS

This application claims priority to China Application Serial Number 201811391898.4, filed Nov. 21, 2018, the disclosure of which is incorporated herein by reference in its entirety.

### BACKGROUND

### Technical Field

The present disclosure relates to an electrical connector assembly.

### Description of Related Art

Pogo pin connectors are widely adopted in electronic devices to achieve electrical connections between electrical components. A common problem with the pogo pin connectors is that they are likely to have rotational offsets which may cause the pogo pins connectors to be in poor contact or even disconnected from corresponding contact pads.

Consequently, how to provide an electrical connector assembly to resolve the aforementioned issues is one of the directions that should be urgently worked on.

### SUMMARY

In view of the foregoing, one of the objects of the present disclosure is to provide an electrical connector assembly that can restrict rotation and maintain a stable electrical connection.

To achieve the objective stated above, in accordance with an embodiment of the present disclosure, an electrical connector assembly is provided and includes a first connector and a second connector. The first connector includes plural pogo pins and two positioning pins located between the pogo pins. The second connector includes plural contact pads and two positioning holes. The contact pads are configured to be electrically coupled with the pogo pins. The positioning holes are located between the contact pads. Each positioning hole is configured to surround and contact a corresponding positioning pin, so as to restrict relative motion between the first connector and the second connector along their connection interface.

In one of more embodiments of the present disclosure, the first connector has two connection regions that are arranged symmetrically and are separated from each other. The pogo pins are distributed inside the connection regions. The two positioning pins are located in the two connection regions respectively.

In one of more embodiments of the present disclosure, a distance between the two positioning pins is greater than or equal to a distance between any pair of pogo pins located in the two connection regions.

In one of more embodiments of the present disclosure, the two connection regions are two arc-shaped regions with opposite concave openings.

In one of more embodiments of the present disclosure, each positioning pin is located at a center of a corresponding arc-shaped region.

In one of more embodiments of the present disclosure, each positioning pin has a tapered end facing a corresponding positioning hole.

In one of more embodiments of the present disclosure, each positioning hole has an inner circumferential surface inclined to match the tapered end of a corresponding positioning pin.

In one of more embodiments of the present disclosure, the tapered end has a taper of substantially 1:20.

In one of more embodiments of the present disclosure, the two positioning holes are electrically coupled with the two positioning pins respectively.

In one of more embodiments of the present disclosure, the second connector has two positioning slots. The first connector further includes two positioning latches configured to be engaged with the two positioning slots.

In sum, the electrical connector assembly of the present disclosure includes two positioning pins located on the first connector and two positioning holes located on the second connector. By engaging the positioning pins with the positioning holes, relative rotation and translation between the first connector and the second connector may be restricted such that the first connector and the second connector maintain a stable electrical connection.

### BRIEF DESCRIPTION OF THE DRAWINGS

To make the objectives, features, advantages, and examples of the present invention, including those mentioned above and others, more comprehensible, descriptions of the accompanying drawings are provided as follows.

FIG. 1 illustrates a perspective view of a first connector of an electrical connector assembly in accordance with an embodiment of the present disclosure.

FIG. 2 illustrates a perspective view of a second connector of the electrical connector assembly in accordance with an embodiment of the present disclosure.

FIG. 3 is a partially enlarged cross-sectional view of the electrical connector assembly shown in FIG. 1 and FIG. 2 viewed along a direction, in which the first connector shown in FIG. 1 and the second connector shown in FIG. 2 are connected.

FIG. 4 is a partially enlarged cross-sectional view of the electrical connector assembly shown in FIG. 1 and FIG. 2 viewed along another direction, in which the first connector shown in FIG. 1 and the second connector shown in FIG. 2 are connected.

### DETAILED DESCRIPTION

For the sake of the completeness of the description of the present disclosure, reference is made to the accompanying drawings and the various embodiments described below. Various features in the drawings are not drawn to scale and are provided for illustration purposes only. To provide full understanding of the present disclosure, various practical details will be explained in the following descriptions. However, a person with an ordinary skill in relevant art should realize that the present disclosure can be implemented without one or more of the practical details. Therefore, these details should not be used to limit the present disclosure.

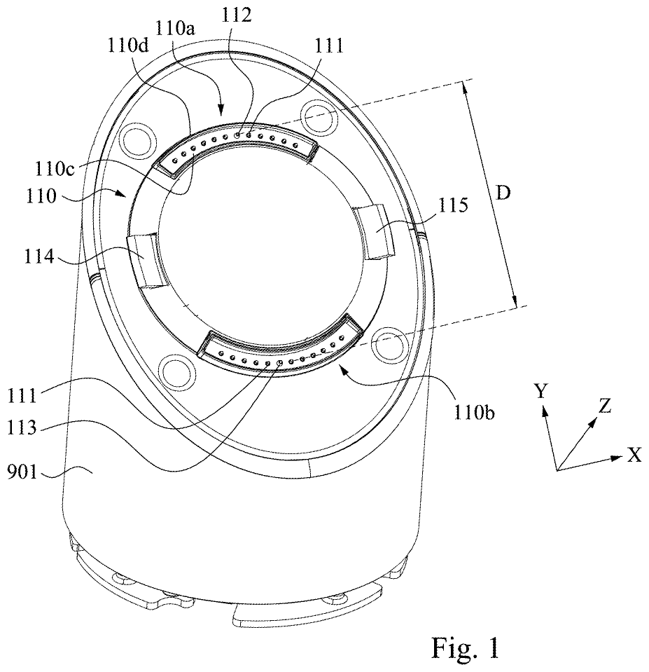

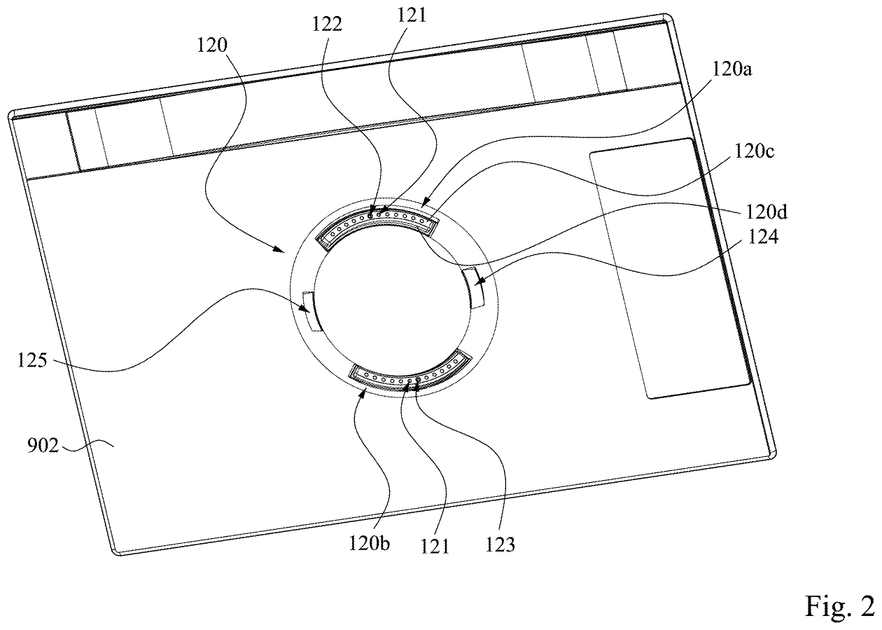

Please refer to FIG. 1 and FIG. 2. FIG. 1 illustrates a perspective view of a first connector 110 of an electrical connector assembly in accordance with an embodiment of the present disclosure. FIG. 2 illustrates a perspective view of a second connector 120 of the electrical connector assembly in accordance with an embodiment of the present disclosure. The electrical connector assembly includes the first connector 110 and the second connector 120 that are configured to be electrically coupled to each other. In the present embodiment, the first connector 110 is disposed on a top end of a tablet docking station 901 (only a portion of which is shown schematically), and the second connector 120 is disposed on the back of a tablet 902. When the second connector 120 is connected to the first connector 110, the tablet docking station 901 may exchange information with the tablet 902 through transmission of electronic signals, or charge the tablet 902.

As shown in FIG. 1, the first connector 110 includes plural pogo pins 111 and two positioning pins 112, 113. The first connector 110 has two connection regions 110a, 110b that are arranged symmetrically and are separated from each other. The pogo pins 111 are distributed inside the connection regions 110a, 110b. The positioning pins 112, 113 are located in the connections regions 110a, 110b respectively, and are positioned between the pogo pins 111.

Specifically, the connection regions 110a, 110b are two arc-shaped regions with opposite concave openings, with the connection region 110a located on the top concave downward, and the connection region 110b located on the bottom concave upward. The positioning pins 112, 113 are substantially located at centers of the connection regions 110a, 110b respectively, such that the positioning pins 112, 113 have a maximum distance therebetween. In other words, a distance D between the two positioning pins 112, 113 are greater than or equal to a distance between any pair of pogo pins 111 located in the two connection regions 110a, 110b. In some embodiments, the positioning pins 112, 113 are made of metal, plastic, or other hard materials. In some embodiments, each of the positioning pins 112, 113 has a diameter greater than that of each of the pogo pins 111.

As shown in FIG. 2, the second connector 120 includes plural contact pads 121 and two positioning holes 122, 123. The contact pads 121 are positioned corresponding to the pogo pins 111, and are configured to be electrically coupled with the pogo pins 111 to enable electric current transmission. The positioning holes 122, 123 are positioned corresponding to the positioning pins 112, 113. The positioning holes 122, 123 are configured to engage with the positioning pins 112, 113, so as to restrict relative motion between the first connector 110 and the second connector 120 along their connection interface, i.e. to restrict relative rotation or translation between the first connector 110 and the second connector 120 along the X-Y plane.

As shown in FIG. 2, the second connector 120 has two arc-shaped connection regions 120a, 120b corresponding to the connection regions 110a, 110b. The contact pads 121 are positioned inside the connection regions 120a, 120b and are distributed in a curved manner. The positioning holes 122, 123 are located in the connection regions 120a, 120b respectively, and are positioned between the contact pads 121. Specifically, the positioning holes 122, 123 are located at centers of the connection regions 120a, 120b respectively.

Due to the arrangement of positioning the positioning pins 112, 113 at the centers of the connection regions 110a, 110b respectively, the positioning pins 112, 113 has a maximum distance therebetween (i.e., the distance D between the two positioning pins 112, 113 are greater than or equal to a distance between any pair of pogo pins 111 located in the two connection regions 110a, 110b respectively). Therefore, if the positioning pins 112, 113 and the corresponding positioning holes 122, 123 can remain within a specified tolerance, all the pogo pins 111 and the corresponding contact pads 121 can also remain within the specified tolerance and thus can be stably electrically connected.

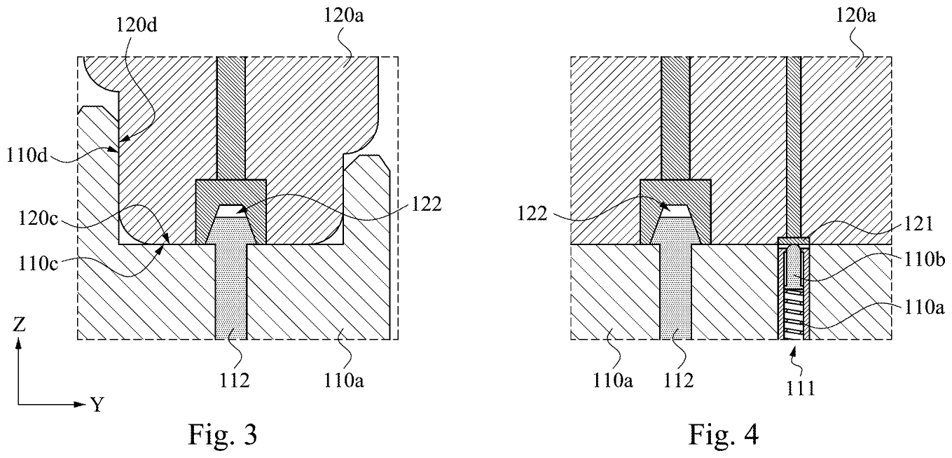

Please refer to FIG. 3 and FIG. 4. FIG. 3 and FIG. 4 are partially enlarged cross-sectional views of the electrical connector assembly shown in FIG. 1 and FIG. 2 viewed along two different directions, in which the first connector 110 shown in FIG. 1 and the second connector 120 shown in FIG. 2 are connected. As shown in FIG. 3, the connection region 110a is a depressed structure (also referring to FIG. 1), and has a bottom surface 110c and a side wall 110d surrounding the bottom surface 110c. The pogo pins 111 and the positioning pins 112, 113 are positioned on the bottom surface 110c, and protrude upward therefrom. The connection region 120a mating with the connection region 110a is a protruding structure (also referring to FIG. 2), and has a top surface 120c and a side wall 120d surrounding the top surface 120c. The contact pads 121 and the positioning holes 122, 123 are positioned on the top surface 120c. In the present embodiment, the connection regions 110a, 110b are mirror-symmetrical to each other, and the connection regions 120a, 120b are also mirror-symmetrical to each other.

As shown in FIG. 4, when the first connector 110 and the second connector 120 are connected, the top surface 120c of the connection region 120a abuts against the bottom surface 110c of the connection region 110a, such that the contact pads 121 are electrically coupled with the pogo pins 111, and the positioning hole 122 surrounds and contacts the positioning pin 112. Engagement between the positioning hole 122 and the positioning pin 112 may restrict rotation of the second connector 120, thereby preventing the contact pads 121 from being misaligned with the corresponding pogo pins 111 and affecting the transmission of electric current between the first connector 110 and the second connector 120.

In some embodiments, the positioning pins 112, 113 and the positioning holes 122, 123 are made of metal or other conductive materials, such that the positioning pins 112, 113 are electrically coupled with the positioning holes 122, 123 respectively when the first connector 110 and the second connector 120 are connected. Therefore, in addition to restricting relative motion between the first connector 110 and the second connector 120 along the interface therebetween (i.e., along the X-Y plane), the positioning pins 112, 113 and the positioning holes 122, 123 may also provide transmission of electric current between the first connector 110 and the second connector 120.

In some embodiments, as shown in FIG. 4, the positioning pin 112 has a tapered end facing the positioning hole 122, such that a top portion of the positioning pin 112 has a substantially trapezoidal cross section. The positioning hole 122 mating with the positioning pin 112 has an inner circumferential surface inclined to match the tapered end of the positioning pin 112. With the structural configuration described above, the positioning pin 112 and the positioning hole 122 may have a larger contact area, thereby improving the efficiency of electric current transmission. In some embodiments, the tapered end of the positioning pin 112 has a taper of substantially 1:20.

As shown in FIG. 4, the pogo pin 111 includes a spring 111a and a head 111b abutting against the spring 111a. When the first connector 110 and the second connector 120 are detached, the head 110b partially protrudes from the bottom surface 110c (as shown in FIG. 1). Conversely, when the first connector 110 and the second connector 120 are connected, the top surface 120c of the connection region 120a abuts against the bottom surface 110c of the connection region 110a, and the contact pad 121 presses the corresponding pogo pin 111. Being pressed by the contact pad 121, the head 111b of the pogo pin 111 moves downward and compresses the spring 111a underneath. In this situation, the spring 111a pushes the head 111b to resist the contact pad 121 with its restoring force, so as to maintain a stable electrical connection between the head 111b and the contact pad 121.

As shown in FIG. 3, when the first connector 110 and the second connector 120 are connected, the side wall 110d of the connection region 110a and the side wall 120d of the connection region 120a abut against each other. The side wall 110d of the connection region 110a has a positioning function, which not only can assist a user to align the pogo pins 111 and the positioning pin 112 with the contact pads 121 and the positioning hole 122 respectively, but also can further restrict relative rotation or translation between the first connector 110 and the second connector 120 to ensure the contact pads 121 and the pogo pins 111 are kept at a stably connected state.

Please refer back to FIG. 1 and FIG. 2. In some embodiments, the first connector 110 further includes two positioning latches 114, 115 (as shown in FIG. 1), and the second connector 120 has two positioning slots 124, 125 (as shown in FIG. 2) positioned corresponding to the two positioning latches 114, 115. As shown in FIG. 1, the positioning latches 114, 115 and the connection regions 110a, 110b are substantially disposed along a circular area on a top surface of the first connector 110. As shown in FIG. 2, the positioning slots 124, 125 and the connection regions 120a, 120b are substantially disposed along a circular area on the back of the second connector 120. When the first connector 110 and the second connector 120 are connected, the positioning latch 114/115 may be moved leftward or rightward to be engaged with the positioning slot 124/125. The engagement between the positioning latches 114, 115 and the positioning slots 124, 125 may restrict relative motion between the first connector 110 and the second connector 120 along a direction perpendicular to the interface between the first connector 110 and the second connector 120 (i.e., along a Z direction, which is perpendicular to the X-Y plane), thereby preventing the first connector 110 and the second connector 120 from be disconnected when a user presses a display (not shown) of the tablet 902.

In some embodiments, the pogo pins 111 are coupled to a control circuit board (not shown). When the control circuit board determines that the pogo pins 111 are connected to the corresponding contact pads 121 (e.g., when the control circuit board receives an electric signal from the second connector 120), the control circuit board may instruct the positioning latches 114, 115 to move into the positioning slots 124, 125, so as to hold the second connector 120 in position.

It should be realized that arrangements of the pogo pins 111, the contact pads 121, the positioning pins 112, 113, the positioning holes 122, 123, and the connection regions 110a, 110b, 120a, 120b shown in FIG. 1 and FIG. 2 are merely illustrated as examples, and the present disclosure is not limited thereto. The connection regions 110a, 110b, 120a, 120b may have shapes other than arcs, and the pogo pins 111 and the contact pads 121 may not be distributed in a curved manner. The positioning pins 112, 113 may be located in the same connection region, and may not be positioned at the centers of the connection regions.

A person with an ordinary skill in relevant art may adjust the quantities and the positions of the positioning pins and the positioning holes base on practical applications. It should be noted that the number of positioning pins/positioning holes has to be at least two to effectively restrict relative rotation and translation between the first connector 110 and the second connector 120. For example, the number of positioning pins/positioning holes may be increased so as to enhance the firmness of the engagement between the first connector 110 and the second connector 120.

In sum, the electrical connector assembly of the present disclosure includes two positioning pins located on the first connector and two positioning holes located on the second connector. By engaging the positioning pins with the positioning holes, relative rotation and translation between the first connector and the second connector may be restricted such that the first connector and the second connector maintain stable electrical connection.

Although the present disclosure has been disclosed by the above embodiments, the present disclosure is not limited thereto. Any person skilled in the art can make various changes and modifications without departing from the spirit and the scope of the present disclosure. Therefore, the protective scope of the present disclosure shall be the scope of the claims as attached.

1. An electrical connector assembly, comprising:
a first connector, comprising:
a plurality of pogo pins; and
two positioning pins located between the pogo pins; and
a second connector, comprising:
a plurality of contact pads configured to be electrically coupled with the pogo pins; and
two positioning holes located between the contact pads, wherein each positioning hole is configured to surround and contact a corresponding one of the two positioning pins, so as to restrict relative motion between the first connector and the second connector along their connection interface;
wherein the first connector has two connection regions that are arranged symmetrically and are separated from each other the pogo pins are distributed inside the connection regions, and the two positioning pins are located in the two connection regions respectively.

2. (canceled)

3. The electrical connector assembly of claim 1, wherein a distance between the two positioning pins is greater than or equal to a distance between any pair of pogo pins located in the two connection regions.

4. The electrical connector assembly of claim 1, wherein the two connection regions are two arc-shaped regions with opposite concave openings.

5. The electrical connector assembly of claim 4, wherein each positioning pin is located at a center of a corresponding one of the two arc-shaped regions.

6. The electrical connector assembly of claim 1, wherein each positioning pin has a tapered end facing a corresponding one of the two positioning holes.

7. The electrical connector assembly of claim 6, wherein each positioning hole has an inner circumferential surface inclined to match the tapered end of a corresponding one of the two positioning pins.

8. The electrical connector assembly of claim 6, wherein the tapered end has a taper of substantially 1:20.

9. The electrical connector assembly of claim 1, wherein the two positioning holes are electrically coupled with the two positioning pins respectively.

10. The electrical connector assembly of claim 1, wherein the second connector has two positioning slots, and the first connector further comprises two positioning latches configured to be engaged with the two positioning slots.
